(19) United States
(12) Patent Application Publication
(10) Pub. No.: US 2019/0178628 A1
(43) Pub. Date: Jun. 13, 2019

(54) SYSTEM AND METHOD FOR DEPTH ESTIMATION USING A MOVABLE IMAGE SENSOR AND ILLUMINATION SOURCE

(71) Applicant: Olympus Corporation, Tokyo (JP)

(72) Inventor: Steven Paul Lansel, East Palo Alto, CA (US)

(21) Appl. No.: 16/099,736

(22) PCT Filed: May 11, 2017
(86) PCT No.: PCT/US2017/032109

§ 371 Date: Nov. 8, 2018

Related U.S. Application Data
(60) Provisional application No. 62/336,372, filed on May 13, 2016.

(51) Int. Cl. G01B 11/00; G06T 7/571; H04N 13/221

(52) U.S. Cl. CPC G01B 11/005; G06T 7/571; H04N 2013/0081; G06T 2207/10068; H04N 13/221

(57) ABSTRACT

Depth estimation may be performed by a movable illumination unit, a movable image sensing unit having a fixed position relative to the illumination unit, a memory, and one or more processors coupled to the memory. The processors read instructions from the memory to perform operations including receiving a reference image and a non-reference image from the image sensing unit and estimating a depth of a point of interest that appears in the reference and non-reference images. The reference image is captured when the image sensing unit and the illumination unit are located at a first position. The non-reference image is captured when the image sensing unit and the illumination unit are located at a second position. The first and second positions are separated by at least a translation along an optical axis of the image sensing unit. Estimating the depth of the point is based on the translation.

### CROSS-REFERENCE TO RELATED APPLICATIONS

The present application claims priority to U.S. Provisional Patent Application No. 62/336,372, filed May 13, 2016, the contents of which is specifically incorporated herein in its entirety by express reference thereto.

### TECHNICAL FIELD

Embodiments of the present disclosure relate generally to imaging systems for depth estimation.

### BACKGROUND

Imaging systems in the field of the present disclosure generally rely on the basic principle of triangulation. The most basic implementation of this principle involves images from only two locations where the effective aperture for the pixels in the two images is small relative to the separation between the two points. (Herein the effective aperture is considered to be the portion of the physical aperture that contains all of the rays that reach the active part of the sensing pixel.) This implementation with two images from different locations is called stereo vision and is often implemented with two separate cameras and lenses. To perform triangulation, a correspondence problem for the images from different locations needs to be solved to determine the location of an object in both images. The location within the images determines a direction from the positions of the cameras to the object. The intersection of these two lines determines the object's location in a scene, which gives the depth of the object. (The depth of an object in the scene is the distance from the imaging system to the object, and the scene is the part of the three-dimensional world outside the camera that is visible to the camera. Typically, the camera captures a two-dimensional representation—an image—of the three-dimensional scene.) In other words, the disparity, which is the shift in the object's position between the two images, is used to determine the depth of the object.

Accordingly, it would be desirable to develop improved imaging systems and methods for estimating the depth of an object.

### BRIEF SUMMARY

A system for performing depth estimation may comprise: a movable illumination unit, a movable image sensing unit having a fixed position relative to the movable illumination unit, a memory, and one or more processors coupled to the memory. The one or more processors are configured to read instructions from the memory to cause the system to perform operations. The operations include receiving a reference image from the movable image sensing unit, receiving a non-reference image from the movable image sensing unit, and estimating a depth of a point of interest that appears in the reference and non-reference images. The reference image is captured when the movable image sensing unit and the movable illumination unit are located at a first position. The non-reference image is captured when the movable image sensing unit and the movable illumination unit are located at a second position. The second position is separated from the first position by at least a translation along an optical axis of the movable image sensing unit. Estimating the depth of the point is based on the translation along the optical axis of the movable image sensing unit.

A method for performing depth estimation may comprise: receiving a reference image from an image sensing unit, receiving a non-reference image from the image sensing unit, and estimating a depth of a target feature appearing in the first or second image. The reference image is captured when the image sensing unit is located at a first position and an illumination unit is located at a fixed position relative to the image sensing unit. The non-reference image is captured when the image sensing unit is located at a second position. The second position is separated from the first position by at least a translation along an optical axis of the image sensing unit. Estimating the depth of the target feature is based on the translation along the optical axis of the image sensing unit.

A system for measuring the depth of an object may comprise: a light source, a camera rigidly coupled to the light source, a positioner coupled to at least one of the camera and the light source, and an image processor coupled to receive images from the camera. The positioner is configured to move the camera and the light source along an optical axis of the camera. The images include at least a front image and a back image captured at, respectively a front position and a back position along the optical axis of the camera, the front position and back position being respectively closer and farther from the scene. The image processor is configured to measure the depth of the object based on the front image and the back image.

### BRIEF DESCRIPTION OF THE DRAWINGS

These and other aspects and features of the present disclosure will become apparent to those ordinarily skilled in the art upon review of the following description of specific embodiments in conjunction with the accompanying figures.

FIG. 1 illustrates an imaging system according to some embodiments.

FIG. 2 illustrates an imaging apparatus according to some embodiments.

FIG. 3 illustrates a front image and a back image captured by an image sensing unit according to some embodiments.

FIG. 4 illustrates an imaging apparatus according to some embodiments.

FIG. 5 illustrates a method for depth estimation according to some embodiments.

FIG. 6 illustrates a method for determining a matching point according to some embodiments.

FIG. 7 illustrates a transformation of an image to polar coordinates according to some embodiments.

FIG. 8 is a simplified illustration of intermediate results of processing a front image and a back image to obtain a depth estimate according to some embodiments.

FIG. 9 is a simplified illustration of intermediate results of scaling candidate patches using a scaling function to obtain a depth estimate according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. The drawings provided herein include representations of devices and device process flows which are not drawn to scale. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The present disclosure describes an imaging system that in some embodiments may estimate the depth of an object. The imaging system may comprise a movable illumination unit and a movable image sensing unit having a fixed position relative to the movable illumination unit. A processor may be coupled to the movable imaging sensing unit in order to receive a first image from the movable image sensing unit captured when the movable image sensing unit and the movable illumination unit are located at a first position, receive a second image from the movable image sensing unit captured when the movable image sensing unit and the movable illumination unit are located at a second position apart from the first position, and estimate a distance between a point of interest in the first or second image and the first or second position first image.

There are a variety of ways to acquire depth images of a scene. For example, active methods send light from imaging equipment into the scene and measure the response. Passive methods analyze ambient light received from the scene. Many methods, including time of flight, structured illumination, and LIDAR, require advanced illumination equipment that requires additional size, cost, and complexity. These additional requirements make such technologies impractical or undesirable for a variety of applications. The present disclosure does not require any such specialized illumination equipment and can operate with nearly any illumination source.

Some passive depth estimation techniques, including stereo vision and camera arrays, require multiple cameras placed in different positions to infer depth. One disadvantage of using multiple cameras is the increased cost and power requirements. Multiple cameras also require careful position and spectral calibration as well as placement in multiple positions. The monocular cameras utilized in embodiments described herein require less equipment so may be cheaper and more compact than multiple camera systems and also may require little or no calibration.

Some imaging systems can measure depth images through multiple exposures including video recording. Techniques include when the camera is moved through different positions or the camera acquires multiple images each with different focal settings. These systems are limited to scenes that are static since any movement within the scene interferes with depth estimation. In some embodiments of the systems disclosed herein only a single exposure is required, consequently the generation of depth images involves less data processing and is more robust for dynamic scenes.

An example of an imaging system may include an endoscope system. However, some approaches to obtaining depth measurements and/or depth images may be incompatible with existing endoscope hardware. For example, many endoscopes include an illumination unit attached to an image acquisition unit. By contrast, many approaches to obtaining depth measurements require a plurality of illumination units and/or a single illumination that moves relative to an image acquisition unit. Accordingly, these approaches to obtaining depth measurements may not work robustly or at all when using conventional endoscope hardware. Accordingly, it would be desirable to obtain depth measurements and/or depth images using an approach that is compatible with existing endoscope hardware. It is further desirable for this approach to be robust and/or scalable (e.g., able to be miniaturized to the requirements of an endoscope).

According to some embodiments, an imaging system may include a movable light source configured to illuminate an object, a movable image sensing unit having a fixed position relative to the light source, and one or more processing units. In some examples, the movable image sensing unit may be configured to capture a first image of the object from a first position and a second image of the object from a second position. In furtherance of such examples, the one or more processing units may be configured to receive information associated with the first and second images and the first and second positions and determine a relative distance between the object and the imaging system based on the received information.

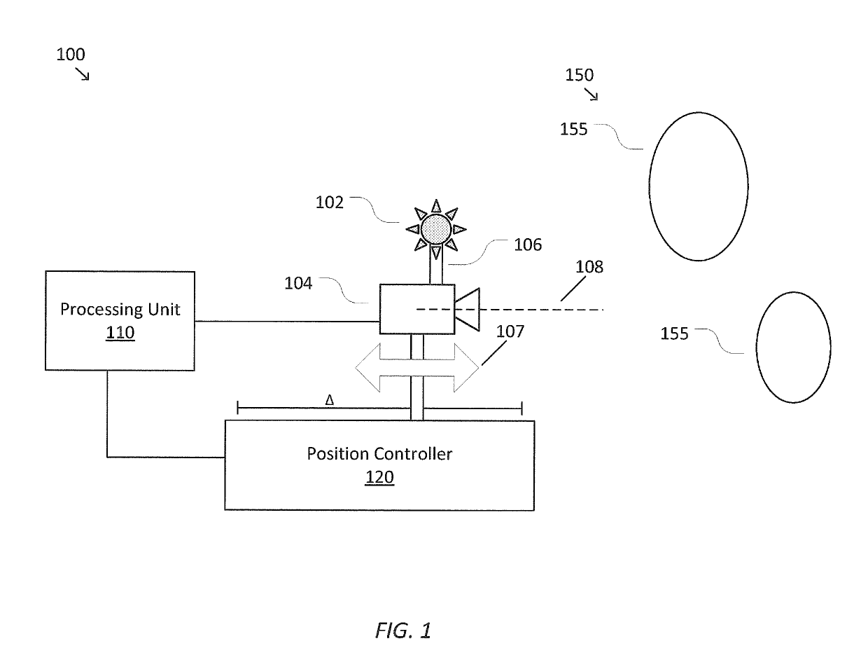

FIG. 1 illustrates an imaging system 100 according to some embodiments. Imaging system 100 includes a movable illumination unit 102 and a movable image sensing unit 104. According to some embodiments, movable illumination unit 102 and movable image sensing unit 104 may have a fixed position relative to one another. For example, movable illumination unit 102 and movable image sensing unit 104 may be coupled to each other by a rigid member 106 and/or may be disposed within a same enclosure/chassis. In some examples, movable illumination unit 102 and movable image sensing unit 104 may be substantially collocated in space. In some examples, movable illumination unit 102 and movable image sensing unit 104 may move independently of one another, in which case the distance between the two units may be kept constant by independently adjusting the positions of each unit to achieve constant separation. According to some embodiments, movable illumination unit 102 and movable image sensing unit 104 may have one mechanical degree of freedom, such as translation 107 along an optical axis 108 of image sensing unit 104. In some embodiments, movable illumination unit 102 and movable image sensing unit 104 may have a plurality of mechanical degrees of freedom, including translations and/or rotations along one or more axes.

A processing unit 110 is communicatively coupled to one or more of movable light source/illumination unit 102 and/or movable image sensing unit 104. According to some embodiments, processing unit 110 may include one or more processor components, memory components, storage components, display components, user interfaces, and/or the like. For example, processing unit 110 may include one or more microprocessors, application-specific integrated circuits (ASICs) and/or field programmable gate arrays (FPGAs) adapted to convert raw image data into output image data. The output image data may be formatted using a suitable output file format including various uncompressed, compressed, raster, and/or vector file formats and/or the like. According to some embodiments, processing unit 110 may be coupled to image sensing unit 104 and/or various other components of imaging system 100 using a local bus and/or remotely coupled through one or more networking components, and may be implemented using local, distributed, and/or cloud-based systems and/or the like.

Changing the position of movable illumination unit 102 and/or movable image sensing unit 104 may be performed manually and/or using automated motion controls, e.g., an actuator, servo mechanism, and/or the like. According to some embodiments, imaging system 100 may include a position controller 120 that is used to adjust the position of movable illumination unit 102 and/or movable image sensing unit 104. According to some embodiments, position controller 120 may receive commands and/or instructions from processing unit 110 to move movable illumination unit 102 and/or movable image sensing unit 104 to a particular location. In some examples, the commands may include information that specifies a target position using an absolute position (e.g., a set of Cartesian and/or polar coordinates), a relative change in position (e.g., a displacement and/or rotation), and/or a velocity. Although a single position controller 120 is depicted in FIG. 1, it is to be understood that imaging system 100 may include a plurality of position controllers, including a different position controller for each of movable illumination unit 102 and movable image sensing unit 104.

A scene 150 includes one or more objects 155 to be imaged using imaging system 100. According to some embodiments, objects 155 may include any feature of interest in scene 150 for which a depth measurement is desired. According to some embodiments, movable illumination unit 102 may be the only significant source of illumination (e.g., a primary source of illumination) to scene 150. Such a scenario may be typical, for example, when imaging system 100 is used as an endoscope inside a human body. However, in some embodiments, there may be additional sources of illumination to scene 150. Such a scenario may be typical, for example, when imaging system is used in outdoor photography applications. When movable illumination unit 102 is not the only significant source of illumination to scene 150, a variety of techniques may be employed to reduce adverse effects associated with the ambient illumination sources. In some examples, the relative contribution of ambient illumination may be reduced. For example, the power (output intensity) of movable illumination unit 102 may be increased. In some examples, movable illumination unit 102 and movable image capturing device/image sensing unit 104 may be synchronized in time to improve signal to noise ratio and power efficiency. Consistent with such embodiments, illumination unit 102 may be designed to emit light with a high intensity over a short duration of time, such that the relative intensity of the ambient illumination may be significantly reduced.

In some examples, movable illumination unit 102 may be a source of isotropic illumination (i.e., illumination radiating equally in all directions). However, in some embodiments, isotropic illumination may not be optimally efficient because some of the illumination travels in directions other than towards scene 150, resulting in wasted illumination output. Accordingly, in some examples, movable illumination unit 102 may be a source of non-isotropic illumination. For example, movable illumination unit 102 may include one or more light emitting diodes, which typically emit illumination as a varying function of angle.

In some examples, movable illumination unit 102 may be a source of electromagnetic radiation, which may include visible light, ultraviolet radiation, infrared radiation, and/or any combination thereof. In some examples, the light/radiation output by movable illumination unit 102 may be polarized, unpolarized, coherent, non-coherent, pulsed, continuous, and/or the like. In some examples, the spectral characteristics of movable illumination unit 102 are optimized based on the sensitivity image sensing unit 104, composition of scene 150, and any ambient illumination. For example, movable illumination unit 102 and movable image sensing unit 104 may be designed to operate in a similar spectral band (e.g., a portion of infrared light) where the ambient illumination has little or no energy. In some embodiments, the wavelengths output by movable illumination unit 102 may correspond to wavelengths at which objects in the scene 150 have higher and/or more uniform reflectance properties.

According to some embodiments, illumination unit 102 may include one or more light sources, lenses, apertures, reflectors, and/or the like. According to some embodiments, lenses, apertures, and/or reflectors may be used to change the angular and/or spatial characteristics of the one or more illumination sources. For example, according to some embodiments, movable illumination unit 102 may include one or more lenses positioned between one or more light sources and scene 150. Consistent with such embodiments, movable illumination unit 102 may simultaneously achieve advantageous properties of a distant illumination source within a physically compact form factor. In some examples, a reflector may be wrapped around the illumination source in order to direct illumination towards scene 150 that would otherwise travel away from scene 150 and be wasted. Accordingly, movable illumination unit 102 may include various components that maximize performance, functionality, and/or energy efficiency during operation.

Movable image sensing unit 104 generally includes any device suitable for converting electromagnetic signals carrying information associated with scene 150 into electronic signals that retain at least a portion of the information contained in the electromagnetic signal. According to some embodiments, movable image sensing unit 104 may include a camera and/or video recorder. According to some embodiments, movable image sensing unit 104 may generate a digital representation of an image contained in the incident electromagnetic signal. The digital representation may include raw image data that is spatially discretized into pixels. For example, the raw image data may be formatted as a RAW image file. According to some examples, movable image sensing unit 104 may include a charge coupled device (CCD) sensor, active pixel sensor, complementary metal oxide semiconductor (CMOS) sensor, N-type metal oxide semiconductor (NMOS) sensor and/or the like. According to some embodiments, movable image sensing unit 104 may include a monolithic integrated sensor, and/or may include a plurality of discrete components. According to some embodiments, movable image sensing unit 104 may include additional optical and/or electronic components such as color filters, lenses, amplifiers, analog to digital (A/D) converters, image encoders, control logic, and/or the like.

According to some embodiments, movable image sensing unit 104 may be configured to capture a first image of scene 150 from a first position and a second image of scene 150 from a second position. In some examples, the first and second positions may be separated by a distance Δ along an optical axis of movable image capture unit 150. Consistent with such examples, position controller 120 may be used to effect the translation of movable image sensing unit 104 by the distance Δ along the optical axis. When the first and second positions are each located along the optical axis of movable image sensing unit 104, the position that is further from the scene is referred to as the back position and the position that is closer to the scene is referred to as the front position. It is to be understood that, in addition to and/or instead of translation along the optical axis of movable image sensing unit 104, various other translations and/or rotations of movable image sensing unit 104 may occur between capturing the first and second images.

Because the relative positioning of movable illumination unit 102 and movable image sensing unit 104 is fixed, movable illumination unit 102 undergoes a corresponding translation and/or rotation between capturing the first and second images so as to maintain a constant relationship with image sensing unit 104. According to some embodiments, the intensity of light/radiation output by movable illumination unit 102 may be the same at the first and second positions. However, in some examples, the intensity of light/radiation output by movable illumination unit 102 may be variable. For example, by using less intensity at the front position than the back position, the captured images may be properly exposed, which may not occur if the same intensity is used by the illumination unit at both positions. Specifically, a properly exposed image is sufficiently bright to avoid noisy, dark regions of the image, but not so bright that significant portions of the image are saturated. In furtherance of such embodiments, the intensity of movable illumination unit 102 at the front and hack positions may be adjusted dynamically based on previously acquired images. The determination of the dynamically-adjusted intensity may be performed by processing unit 110, in which case movable illumination unit 102 may receive a signal from processing unit 110 that indicates the desired intensity.

According to some embodiments, movable image sensing unit 104 may be configured to capture images in addition to the first and second images. In some examples, the first and second images may be selected from among a sequence of three or more images captured by movable image sensing unit 104. In some embodiments, movable image sensing unit 104 may continuously acquire images at a video frame rate.

As depicted in FIG. 1, the same image sensing unit (movable image sensing unit 104) and illumination unit (movable illumination unit 102) are used to capture the front and back images. It is to be understood, however, that in various embodiments different image sensing units and/or corresponding different illumination units may be used to capture the front and back images, respectively. In accordance with such embodiments, one or more of the different illumination units and/or image sensing units may not be movable.

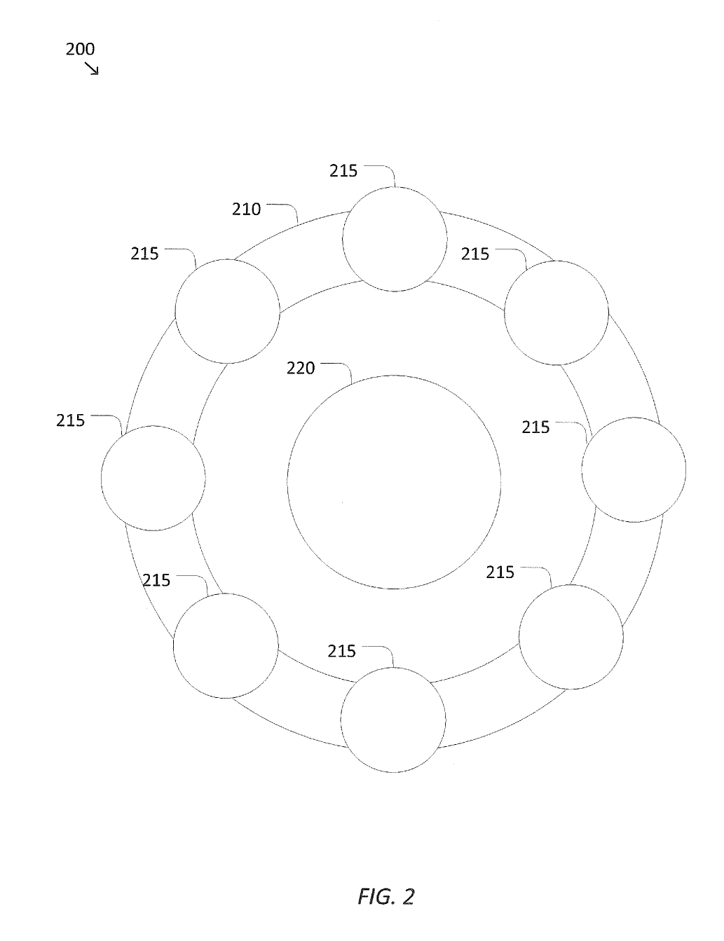

FIG. 2 illustrates an imaging apparatus 200 according to some embodiments. Imaging apparatus 200 includes an illumination unit 210 and an image acquisition or image sensing unit 220. According to some embodiments consistent with FIG. 1, illumination unit 210 may correspond to movable illumination unit 102 and image sensing unit 220 may correspond to movable image sensing unit 104.

Illumination unit 210 includes one or more illumination sources 215. In some examples, illumination unit 210 may include a single illumination source 215. However, in order to increase the output intensity, uniformity, and/or other desirable characteristic of the illumination, illumination unit 210 may include a plurality of illumination sources 215 as depicted in FIG. 2. According to some embodiments, the plurality of illumination sources 215 may be arranged such that each of the plurality of illumination sources is approximately the same distance from objects in the scene being imaged by image sensing unit 220. Consistent with such embodiments, the plurality of illumination sources may be arranged in an annular ring configuration. The annular arrangement may permit highly uniform illumination of objects in the scene, including objects that are off-center relative to the ring of lights or illumination sources 215. More specifically, an off-center object that receives a disproportionately high amount of illumination from the illumination sources 215 on the near side of the ring will receive a disproportionately low amount of illumination from the illumination sources 215 on the far side of the ring. This built-in compensation mechanism results in uniform illumination of objects in the scene.

According to some embodiments, all or part of image sensing unit 220 may be located within the ring of illumination sources 215. For example, as depicted in FIG. 2, a portion of image sensing unit 220 corresponding to a camera lens is positioned at or near the center of the ring of illumination sources 215. In some examples, this arrangement may be found to be advantageous for a number of reasons. First, nearly the entire portion of the scene within the field of view of image sensing unit 220 receives illumination from illumination unit 210. Second, it avoids a problem that may occur when a point illumination source (e.g., a single illumination source) is placed such that there is a large angle between the line connecting image sensing unit 220 and an object in the scene and the line connecting illumination unit 210 and the object. Specifically, in the latter arrangement, it is possible that an object that is viewable to image sensing unit 220 is not illuminated by illumination unit 210 due to an obstruction (e.g., shadowing). In some embodiments, the depth of a shadowed object in the scene cannot accurately be determined. Thus, when image sensing unit 220 is located within the ring of illumination sources 215 the problem of shadowing may be reduced and/or eliminated.

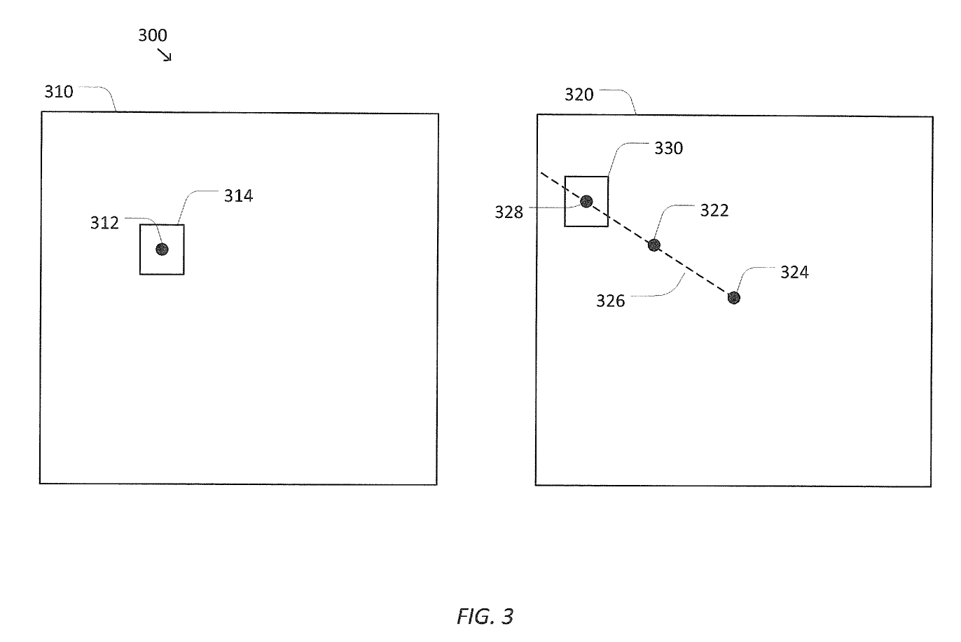

FIG. 3 illustrates a reference image 310 and a non-reference image 320 captured by an image sensing unit, such as movable image sensing unit 104, according to some embodiments. Reference image 310 and non-reference image 320 correspond to images of a scene, such as scene 150, captured before and after the image sensing unit undergoes a translation along its optical axis.

A reference point 312 in reference image 310 is selected for performing depth estimation to determine the distance between the image sensing unit at the reference position and the location in the scene corresponding to reference point 312. In some examples, reference point 312 may correspond to a target feature and/or other feature of interest in reference image 310 that may be manually and/or automatically selected. In some examples, a plurality of points in reference image 310 are selected as reference points. In some examples, all of the points in reference image 310 are selected as reference points, in which case a depth image—an image in which a depth estimate for each point in the image has been calculated—is obtained. For illustrative purposes, a single reference point 312 is depicted in FIG. 3. Reference point 312 is located within a reference patch 314, where reference patch 314 corresponds to a particular region or point within reference image 310.

Referring to non-reference image 320, a point 322 is at the same relative position within non-reference image 320 as reference point 312 within reference image 310 (e.g., at the same image coordinates and/or the same pixel address). A point 324 is the epipole 324 that shows the projection of the optical center of the imaging system at the position used to capture the reference image as seen in the non-reference image. In an embodiment in which the image sensing unit has moved along its optical axis and has not undergone any other translations and/or rotations, point 324 lies at the center of non-reference image 320. An epipolar ray 326 extends from epipole 324 through point 322 and to the edge of non-reference image 320. Each point along ray 326, and/or a subset of points along epipolar ray 326, is referred to as a candidate point. In an embodiment in which the image sensing unit has moved along its optical axis and has not undergone any other translations and/or rotations, one of the candidate points on epipolar ray 326 corresponds to reference point 312 in terms of viewing the same object in the scene. This follows from the general principal that the locations of points in the scene translate along radial lines emanating from the center point of the image when the image sensing unit is moved along its optical axis closer to and/or further from the scene. The magnitude of the translation is dependent on the depth of the points in the scene relative to the image sensing unit. In embodiments in which the image sensing unit has undergone translations and/or rotations other than along its optical axis, such translations and/or rotations may be accounted for when determining the candidate points by using correction techniques that would be readily apparent to one of ordinary skill in the art.

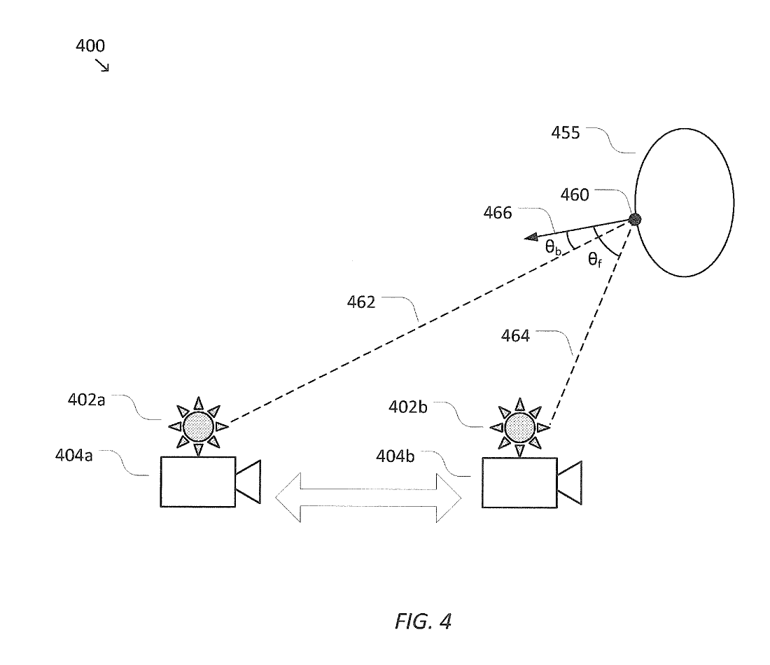

In order to ascertain which of the candidate points corresponds to reference point 312, a non-reference point 328 is selected from among the candidate points. Non-reference point 328 is located within a non-reference patch 330, where non-reference patch 330 corresponds to a particular region or point within non-reference image 320. A cost associated with non-reference patch 330 is computed using a cost function to quantify the similarity between non-reference patch 330 and reference patch 314. The cost function is described below with reference to FIG. 4. According to some embodiments, the cost of each candidate point is computed using the cost function, and the point having the minimum cost among the candidate points is determined to match reference point 312.

FIG. 4 illustrates an imaging apparatus 400 according to some embodiments. According to some embodiments consistent with FIGS. 1-3, the features depicted in FIG. 4 illustrate properties of the cost function. The movement of an illumination unit, such as illumination unit 102, is represented by an illumination unit 402a-b depicted at a back position and a front position, respectively. Likewise, the movement of an image sensing unit, such as image sensing unit 104, is represented by an image sensing unit 404a-b at a back position and a front position, respectively. Image sensing unit 404a-b is configured to acquire images of an object 455. An object point 460 is located on a surface of object 455. Displacement vectors 462 and 464 represent the distance between illumination unit 402a-b and object point 460 when illumination unit 402a-b is located at the back and front positions, respectively. A surface normal vector 466 represents the surface normal of object 455 at object point 460.

According to some embodiments, the cost function may be represented as:

x=c(s(r_{b},r_{f})\vec{p_{b}},\vec{p_{f}}) Eq. 1

In this equation, x represents the cost, c represents the cost function, s represents a scaling function, r_{b} and r_{f} represent a back radius and a front radius, respectively, and \vec{p_{b}} and \vec{p_{f}} represent light intensity measurements associated with the back patch and the front patch extracted from the captured images and arranged into vectors, respectively.

The back radius and front radius are the distances between the back point and front point and the center point at the relative center of the image, respectively. These distances are generally measured using physical units on the image sensor contained in the movable image sensing unit 104. In some examples, these hack and front radii may be determined by calculating the distance in units of pixels and multiplying by the sensor's pixel pitch.

The above equation may be contrasted with a simplified cost function c(\vec{p_{b}},\vec{p_{f}}) that does not include the scaling function. For example, the simplified cost function may employ sum of squared error and/or sum of absolute difference techniques. However, these simplified cost functions may not be well-suited for accurate cost determination when using an imaging system, such as imaging system 100, where the illumination unit and the image sensing unit move with a fixed relationship relative to each other. When using such an imaging system, the scaling function is used to account for the change in illumination between the front image and the back image.

According to some embodiments, the scaling function may be represented as:

$$s ( {r}_{b} , {r}_{f} ) = \frac{1}{ρ} ( 1 + \frac{{f}^{2} {sin}^{2} ( {α}_{f} )}{{r}_{b}^{2}} - {cos}^{2} ( {α}_{f} ) ) \qquad Eq . 2$$

where α_{f} as the angle between the optical axis of an image sensing unit and a displacement vector. With reference to FIG. 4 as an example, the image sensing unit would be 404b and the displacement vector would be 464.

In this equation, ρ is a ratio given by

$$\frac{cos {θ}_{b}}{cos {θ}_{f}} ,$$

f represents a focal length of the image sensing unit, and α_{f} is given by

$$tan ( {α}_{f} ) = \frac{{r}_{f}}{f} .$$

Referring to the ratio

$$ρ = \frac{cos {θ}_{b}}{cos {θ}_{f}} ,$$

θ_{b} and θ_{f} represent a back angle and a front angle, respectively. The back angle is the angle between surface normal vector 466 and displacement vector 462, and the front angle is the angle between surface normal vector 466 and displacement vector 464. In practice, the values of θ_{b} and θ_{f} may be unknown. In such a case, an equal angle assumption may be applied, where θ_{b} and θ_{f} are assumed to be the same and ρ is assumed to be 1. In some examples, a more accurate estimate of ρ may be determined through a variety of techniques. For example, one such technique may include creating a first estimate of the depth using a constant estimate of ρ such as 1 (i.e., the equal angle assumption) and/or a value of ρ that varies based on the position in the image and assumptions about the geometry of observed scenes. Such a first estimate of depth may then be used to create a more accurate estimate of ρ by calculating the surface normals from the depth estimate and directly calculating ρ from θ_{b} and θ_{f}. The improved value of ρ may then be used to create a more accurate depth image. It is to be understood that such an iterative approach that alternatively estimates depth and ρ is only one possible approach, and that many other approaches would be understood to one skilled in the art.

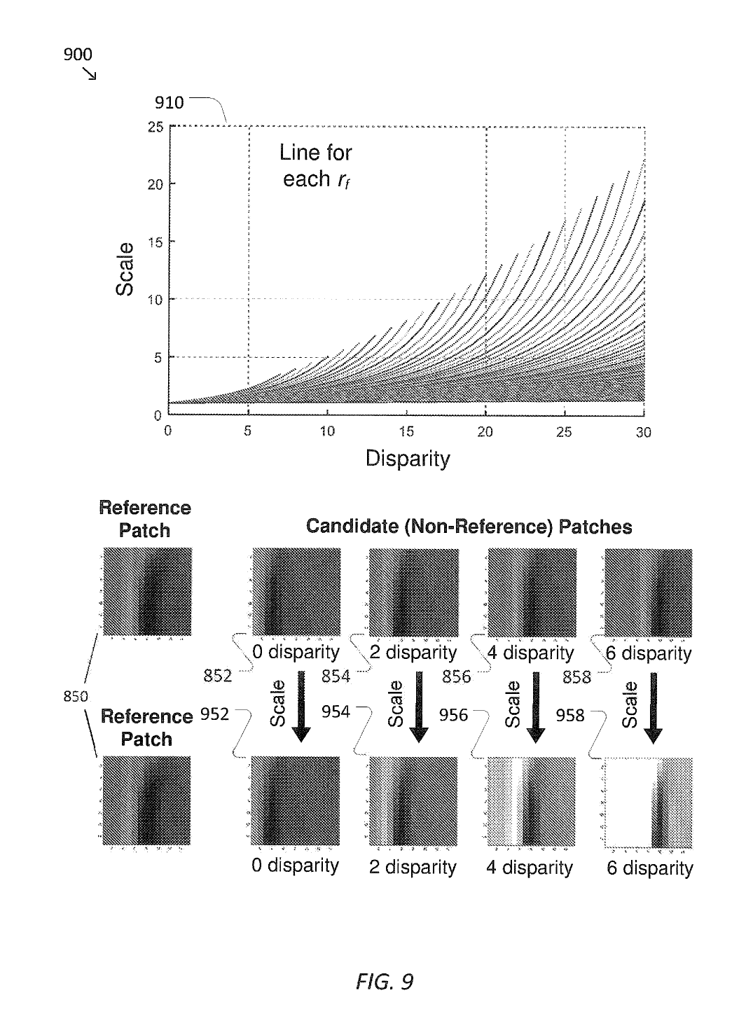

This cost function may be explained intuitively with reference to the scale-versus-disparity plots in the graph of FIG. 9 as follows. When a candidate point is very near the reference point, i.e., when the disparity is small, the location in the scene that corresponds to both the reference point and the candidate point is very far away. This is because the translation of the image sensing system has caused the appearance of the point to vary only slightly due to the relatively small translation compared to the distant location in the scene. In this event, the change in illumination of the location in the scene between the capture of the two images (e.g., the intensity difference) is very small based on the square falloff law. In this case, the value of the scaling factor is near 1. The back patch and front patch are nearly directly compared since they should be approximately equal.

Alternatively, when the reference point and candidate point are distant from each other, i.e., when the disparity is large, the point in the scene that corresponds to both the reference point and the candidate point is relatively near the front position. The forward translation of the image sensing system has caused the appearance of the point to vary greatly due to the significant translation compared to the relatively close distance to the point in the scene. Therefore, the values in the front image are significantly brighter than the back image because the relatively large difference in distance between the point in the scene and the illumination unit according to the square falloff law. In this case, the scaling factor is greater than 1 in order to increase the brightness of the back patch. The scaled up back patch and the front patch can now be directly compared since the illumination effect has been removed.

It is to be understood that various corrections may be included in the above calculations, for example, to account for limitations and/or non-idealities of the components of the imaging system. In some examples, when the illumination unit is non-isotropic (i.e., there is a significant variation in illumination intensity in various directions throughout the scene), the angular distribution of the illumination unit may be properly calibrated prior to performing the cost and scaling factor calculations. Consistent with such embodiments, an appropriate scalar multiplication may be applied to the measurements in order to account for the differing intensity at the corresponding angle from the non-isotropic illumination unit.

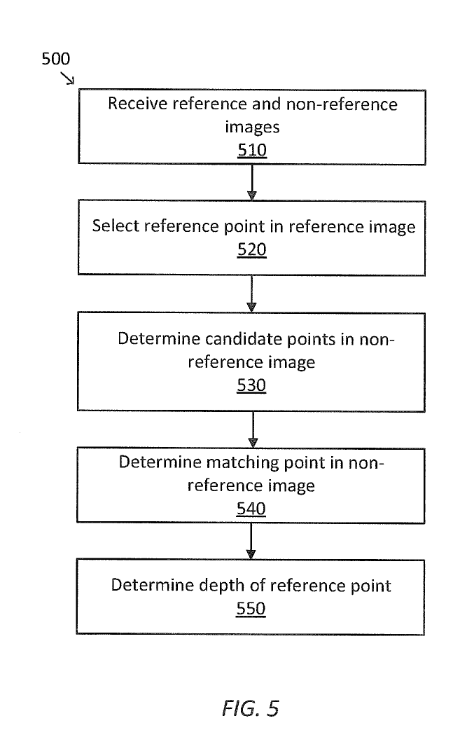

FIG. 5 illustrates a method 500 for depth estimation according to some embodiments. According to some embodiments, method 500 may be performed by a processor, such as processing unit 110 in FIG. 1.

With reference to FIGS. 1 and 5, at a process 510, a reference image and a non-reference image are received. According to some embodiments, the reference and non-reference images are captured using an image sensing unit, such as image sensing unit 104. According to some embodiments, the reference image may be captured when the image sensing unit and an illumination unit, such as illumination unit 102, are located at a first position and the non-reference image may be captured when the image sensing unit and the illumination unit are located at a second position apart from the first position. According to some embodiments, the first and second positions may be determined by the processor and transmitted to a position controller, such as position controller 120 that is configured to move image sensing unit 104 to the first and second positions. According to some embodiments, a plurality of images may be captured at each of the first and second positions, where each of the plurality of images is captured at a different illumination intensity. Consistent with such embodiments, the first and second images may be synthesized from the plurality of images such that various regions within the scene are properly exposed (e.g., sufficiently bright to mitigate noise but not too bright as to cause saturation). According to some embodiments, process 510 may include receiving a stream of images, such as a video stream, and selecting the reference image and non-reference image from among the frames of the image stream. For example, the non-reference and reference images may correspond to consecutive frames and/or non-consecutive frames such that a significant displacement between the first and second positions occurs.

According to some embodiments, various image processing techniques may be applied to one or more of the reference and non-reference images before, during, and/or after being received during process 510. According to some embodiments, geometric distortions associated with the image sensing unit may be removed using techniques known to one skilled in the art. According to some embodiments, noise reduction techniques, such as adaptive blurring and/or other noise reduction techniques known to one skilled in the art, may be applied to the images. According to some embodiments, problem regions, including regions where illumination is reflected directly from the illumination unit back to the image sensing unit, causing local saturation, and/or regions that are not illuminated by illumination due to, e.g., shadowing, may be detected. According to some embodiments, the depth of problem regions may not be accurately estimated using the techniques described below may instead be estimated using nearby regions and/or alternative techniques specifically developed for problem regions. According to some embodiments, ambient light may be removed from the images. For example, a baseline image may be acquired at each position without any illumination from the illumination unit, and the baseline image may be subtracted from the reference and/or non-reference images to remove ambient light from the reference and/or non-reference images. According to some embodiments, noise reduction techniques may be applied to the baseline images, particularly when the amount of ambient light is low and prone to noisy images.

At a process 520, a reference point in the reference image is selected. According to some embodiments, the reference point may be any point of interest at which the distance between the point of interest and the first or second position is desired to be known. For example, the reference point may be a point on an object in the scene captured by the reference image. According to some embodiments, when forming a depth image, each of the points and/or pixels in the reference image may be selected as a reference point.

At a process 530, candidate points in the non-reference image are determined. Candidate points are those points that could conceivably match the reference point in the sense that they correspond to the same absolute three-dimensional location in the scene. For example, when the reference point corresponds to a location in the scene, the candidate points are a set of points in the second image that potentially correspond to the same location in the scene. The candidate points are dependent on the difference between the first position and the second position. According to some embodiments, the difference between the first position and the second position is a translation along an optical axis of the image sensing unit. In furtherance of such embodiments, the candidate points may be the set of points lying on an epipolar ray 326 extending from epipole 324 of the non-reference image and through a point having the same relative position (e.g., coordinates and/or pixel address) within the non-reference image as the reference point within the reference image. In some embodiments, the non-reference image may be transformed into a polar coordinate system prior to determining the candidate points. In furtherance of such embodiments, the candidate points may be the set of points lying on a straight line of constant angle and varying radius within the second image as the reference point within the reference image. According to some embodiments, the difference between the first and second positions may include motion along axes other than the optical axis of the image sensing unit and/or rotations. In furtherance of such embodiments, the candidate points may be determined by applying appropriate corrections to account for the translation and/or rotation.

In some examples, the candidate points may be equally spaced in terms of the back radius values that they correspond to. In some examples, the total number of candidate points may be chosen based on desired computational speed, depth accuracy, and/or resolution of the images. In some examples, it may be desirable to not use equal spacing in order to more efficiently and accurately measure depth.

Another embodiment of the disclosure involves selection of the candidate points by iterating over depth values. Choosing to iterate over possible depth values creates a sampling of possible depth estimates that does not vary based upon the position of the reference point. Iterating over equally-spaced back radius values, as described above, does not achieve such a uniform sampling. Thus, choosing candidate points by equally-spaced depth values may result in improved accuracy and/or speed. According to some embodiments, the back radius corresponding to a particular front depth may be determined using the following equation:

$${r}_{b} = \frac{{fd}_{f} sin ( {α}_{f} )}{Δ + {d}_{f} cos ( {α}_{f} )} \qquad Eq . 3$$

In this equation, d_{f} represents the front depth. In this manner, a candidate point (corresponding to a back radius value) may be specified based on front depth.

Candidate points may be constrained based on the configuration of the imaging system and/or the first and/or second positions. According to some embodiments, a minimum back radius value may be specified based on the imaging hardware and/or the position of the front point. For example, a minimum focusing distance of the image sensing unit may place a lower hound on the front distance that can be estimated. In some examples, the minimum back radius may be selected based on the intended application of the imaging system, which may set a practical lower limit on the back radius. Accordingly, candidate points corresponding to a front distance less than the minimum focusing distance may be eliminated. According to some embodiments, a maximum back radius may be similarly specified. For example, candidate points corresponding to a back radius that is greater than the front radius of the reference point may be eliminated because points shift towards the center of the image as the image sensing unit moves back. Thus, the back radius of the matching point is constrained to be smaller than the front radius of the reference point.

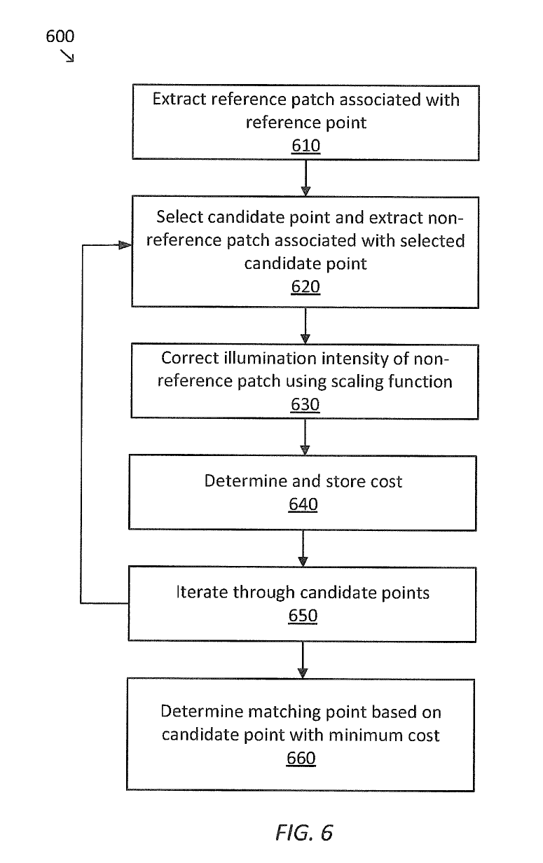

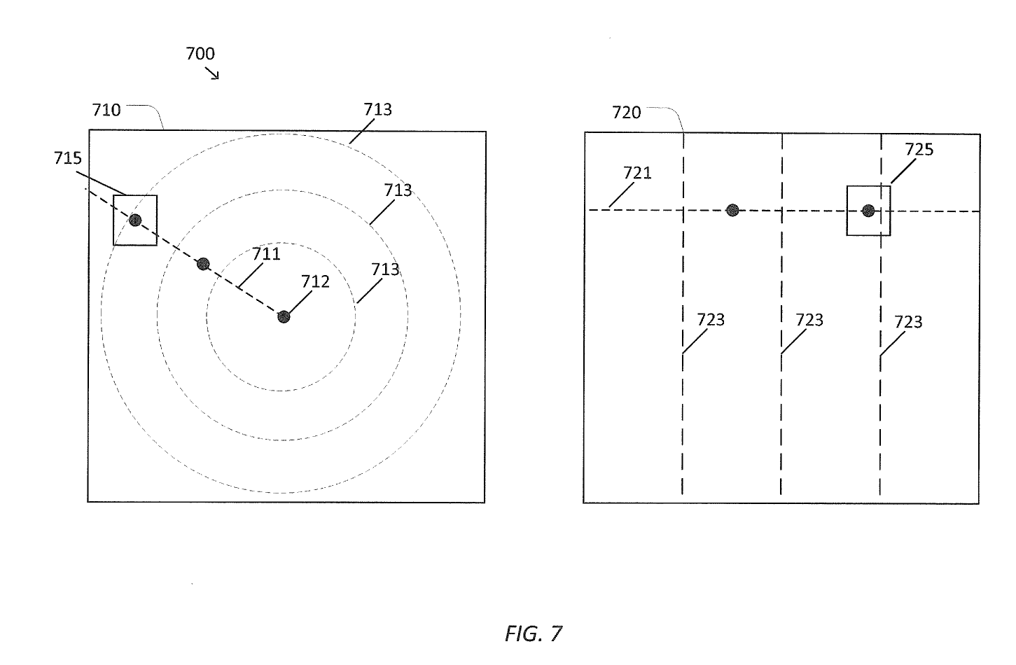

At a process 540, a matching point in the non-reference image is determined. The matching point is a point in the non-reference image that corresponds to the same three-dimensional location in the scene (e.g., a point on the surface of an object in the scene) as the reference point in the reference image. According to some embodiments, the matching point may correspond to one of the candidate points determined at process 530. In some examples, a cost function may be used to determine which of the candidate points is most likely to be the matching point, as discussed in further detail below with reference to FIGS. 6 and 7.

At a process 550, a depth of the reference point is determined. According to some embodiments, the depth may correspond to the distance between the reference point and the first or second position. In some examples, the depth may be determined based on the difference between the front radius and the back radius, as described above with reference to FIG. 4. In some embodiments, the depth is calculated using Equation 18 below.

In some examples, method 500 may conclude at process 550. However, in some embodiments, processes 520-550 may be iteratively performed to determine the depth of a plurality of points in the reference image. For example, in order to form a depth image, processes 520-550 may be performed using each point in the reference image as a reference point. According to some embodiments, processes 520-550 may be performed on a plurality of points in the reference image serially and/or in parallel. Moreover, post-processing may be performed on a measurement and/or depth image obtained using method 500. Examples of post-processing include removing noise, unreliable estimates, and/or identifying areas where no reliable depth estimate was obtained. Post-processing techniques may be particularly effective for depth images due to the slowly varying property of the 3D geometry of many scenes. For example, areas where no reliable depth estimate was obtained may be remedied by using nearby values in the depth image.

FIG. 6 illustrates a method 600 for determining a matching point according to some embodiments. According to some embodiments consistent with FIGS. 1-5, method 600 may represent an implementation of process 540 for determining a matching point in the non-reference image. According to some embodiments, method 600 may be performed by a processor, such as processing unit 110.

At a process 610, a reference patch associated with the reference point is extracted. According to some embodiments, the reference patch may correspond to a region surrounding the reference point. The patch may have a fixed shape such as approximately rectangular, wedge, or circular shape. According to some embodiments, it may be desirable for the size of the patch to vary based on the position with the image. For example, smaller patches may be desired near the center of the image. Smaller patches or patches that are not centered at the associated point may be desired near the edges or center of the image due to the limited number of useful pixels in these regions.

At a process 620, a candidate point is selected and a non-reference point associated with the candidate point is extracted. According to some embodiments, candidate points may be selected by iterating over the candidate points determined at process 530. Once the candidate point is selected and/or determined, a non-reference patch corresponding to a region surrounding the selected candidate point may be extracted.

At a process 630, the illumination intensity of the non-reference patch is corrected using a scaling function. According to some embodiments, the movement of the illumination unit between the first and second images causes the illumination to change based on an inverse square law. In order to correct for this change in illumination, the intensity of the non-reference patch may be multiplied by the scaling function s(r_{b},r_{f}) as described above with reference to FIG. 4.

At a process 640, the cost of the non-reference patch is determined and stored. As discussed above with reference to FIG. 4, the cost may be determined using the cost function c(s(r_{b},r_{f})\vec{p_{b}},\vec{p_{f}}). According to some embodiments, a lower cost indicates that the non-reference patch is more similar to the reference patch and therefore more likely to correspond to the same three-dimensional location in the scene.

At a process 650, the candidate points are iterated through. According to some embodiments, after process 640, a new candidate point is selected and method 600 proceeds to process 620 to determine the cost of the new candidate point. According to some embodiments, method 600 proceeds to a process 660 when a cost for all of the candidates has been computed.

At a process 660, the matching point is determined based on the candidate point with the minimum cost. That is, the matching point is the candidate point identified as being most similar to the reference point based on the cost function. Once the matching point is determined, method 600 is concluded and method 500 may proceed to process 550 to determine the depth of the reference point based on the matching point.

FIG. 7 illustrates a transformation 700 of an image to polar coordinates according to some embodiments. According to some embodiments, in order to more efficiently perform the calculations disclosed herein, it may be helpful to first apply transformation 700 to the back image and/or the front image. By applying transformation 700, the patches associated with reference point and candidate points may be extracted more efficiently.

According to some embodiments, transformation of an original image 710 to polar coordinates may permit patches to be extracted from a transformed image 720 without concern for the underlying pixel arrangement. For example, according to some embodiments, all candidate points in original image 710 lie along epipolar ray 711 extending outward from epipole or center point 712. Without a transformation, the candidate points generally do not lie at the center of a pixel location, so some interpolation may be needed for each patch due to the misaligned pixel grid. By first performing such a transformation, patches for all candidate points are accessible along a vertical and/or horizontal line of the transformed image 720 without interpolation.

In original image 710, circles 713 have a constant radius relative to center point 712. In transformed image 720, ray 711 is transformed to a horizontal line 721, and circles 713 are transformed to vertical lines 723. According to some examples, each point in transformed image 720 may correspond with a point in original image 710. According to some embodiments, transformed image 720 is based on a polar coordinate system. According to some examples, a patch 715 in original image 710 may contain much of the same information as a corresponding patch 725 in transformed image 720. However, some differences may arise due to the spatial transformation. To account for these differences, in some examples the same transformation may be applied to both the reference and non-reference images in order to compare patches between the two images.

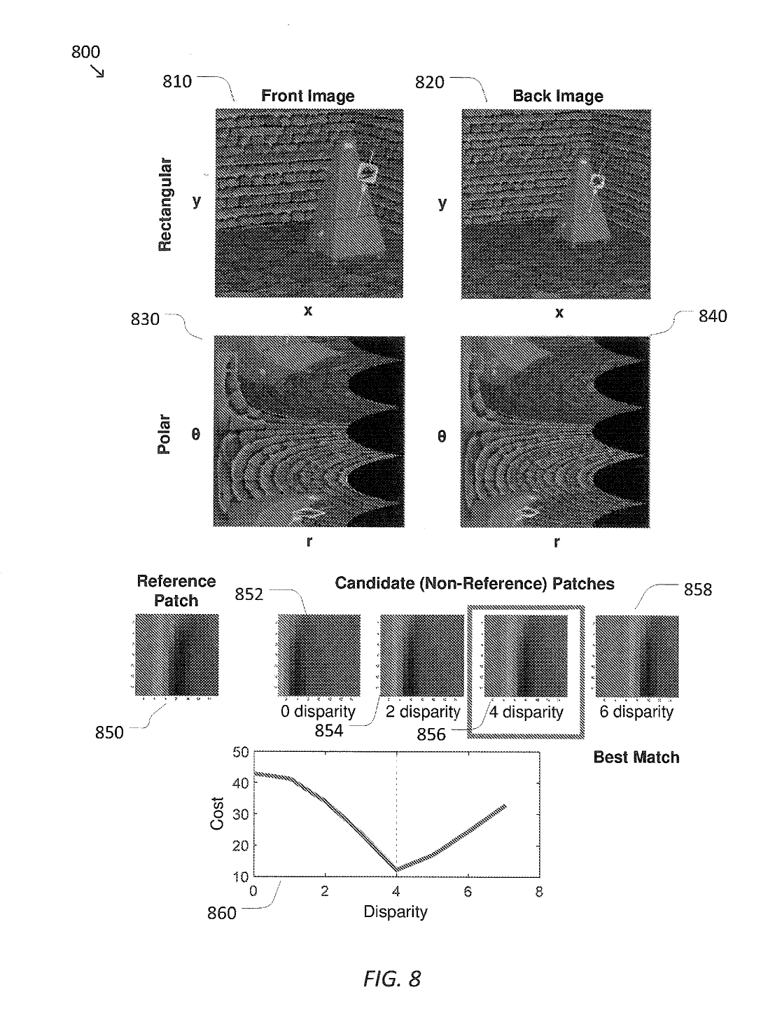

FIG. 8 is a simplified illustration of intermediate results 800 of processing a front image 810 and a back image 820 to obtain a depth estimate according to some embodiments. According to some embodiments consistent with FIGS. 1-7, front image 810 and/or hack image 820 may be obtained using an image acquisition unit, such as image acquisition unit 220, and processed using a method for depth estimation, such as method 500.

First, front image 810 and back image 820 are transformed from rectangular coordinates into polar coordinates, resulting in transformed front image 830 and transformed back image 840. Next, a reference patch 850 is selected in transformed front image 830, and candidate patches 852-858 corresponding to reference patch 850 are determined in transformed back image. Candidate patches 852-858 are each located along a horizontal line in transformed back image 840 (i.e., an epipolar line), the horizontal line being at the same vertical position within transformed back image 840 as reference patch 850 within transformed front image 830. Candidate patches 852-858 are each separated by two pixels along the horizontal line, as indicated by the disparity value (i.e., the offset in pixels between a given candidate patch and reference patch 850).

Next, a cost is computed for each of candidate patches 852-858 using a cost function, as depicted in a cost v. disparity plot 860. A lower cost indicates that a given candidate point is more similar to reference patch 850, while a higher cost indicates that a given candidate is less similar to reference patch 850. As indicated in plot 860, candidate point 856, with a disparity of 4 pixels, has the lowest cost (i.e., the best match). Subsequent computations may be performed to convert a value of 4 pixels into a depth estimate based on the known geometry of the apparatus used to obtain front image 810 and back image 820.

FIG. 9 is a simplified illustration of intermediate results 900 of scaling candidate patches 852-858 using a scaling function to obtain a depth estimate according to some embodiments. According to some embodiments consistent with FIG. 8, the use of a scaling function may result in a more robust determination of the depth estimate relative to embodiments that do not use a scaling function. In particular, the scaling function accounts for the illumination source moving further away from the scene when capturing back image 820 relative to front image 810. The movement of the illumination unit results in features of back image 820 being darker than front image 810 based on an inverse square law. The scaling function is illustrated using scale v. disparity plot 910. As depicted in plot 910, the particular scaling factor for a given candidate point is a function of both disparity and front radius (i.e., the horizontal coordinate of reference patch 850 within transformed front image 830). Scaled candidate patches 952-958 are generated by multiplying the intensity of candidate patches 852-858 by a corresponding scaling factor based on the scaling function depicted in plot 910. After scaling, the cost of each of scaled candidate patches 952-958 is computed using a cost function. As illustrated in FIG. 9, the cost function is more robust due to the scaling. For example, scaled candidate patch 958 is less likely to be erroneously identified as the best match to reference patch 850 relative to candidate patch 858 because the scaling function has caused the intensity to become “washed out.”

### Derivation of Scaling Function

Consider a scene entirely illuminated from a single light source. According to the inverse square law, the amount of light that falls on a small planar region with a fixed area oriented normally to the direction of light propagation is inversely proportional to the squared distance between the light source and the plane. If the plane is not oriented normal to the direction of propagation, the amount of light falling on it is reduced. Let dᵢ be the distance between the light source and the center of the plane. Let θᵢ be the angle between the plane's normal and the direction of the propagation of light. The amount of light falling on a plane at such an orientation and distance from the light source is proportional to

$$\frac{cos {θ}_{1}}{{d}_{i}^{2}} .$$

Consider an object in the scene and a small plane normal to the object's surface at a point. Some of the incident light will be reflected off this point and be measured by the imaging system. The measurement will be given by

$${m}_{i} = c * ( \frac{cos {θ}_{i}}{{d}_{i}^{2}} ) \qquad Eq . 4$$

where c is a constant that takes into account the object's albedo, brightness of the illumination unit, and the camera's optical to electronic conversion. Note this constant does not depend on the object's distance or orientation. Here the measurements are assumed to be linearly related to the amount of light, which means no post-processing, such as a gamma transform, is applied.

Let θ_{b} be the angle between surface normal vector 466 and displacement vector 462, as described above with respect to FIG. 4. Similarly, let θ_{f} be the angles between surface normal vector 466 and displacement vector 464. Consider the back point in the back image that corresponds to object point 460. Also consider the front point in the front image that corresponds to object point 460. Let m_{b} and m_{f} be the values at these points in the back image and front image, respectively. The following equations are used to model the measurements.

$$\begin{matrix}{m}_{b} = k * ( \frac{cos {θ}_{b}}{{d}_{b}^{2}} ) & Eq . 5 \\ {m}_{f} = k * ( \frac{cos {θ}_{f}}{{d}_{f}^{2}} ) & Eq . 6\end{matrix}$$

Notice the same constant k has been used in both equations because of no changes to the overall system. For example the object's albedo is the same because the camera and scene are assumed to not have moved. The intensity of the illumination unit during capture of the front and back images has been assumed to be equal or scaled appropriately. In some examples, the same camera may be used so the optical to electronic conversion is assumed to be the same for both images or already removed.

Additionally, the bidirectional reflectance distribution function is assumed to have approximately equal values for the corresponding directions of displacement vectors 462 and 464. Such assumption is valid for many objects that are approximately Lambertian. This assumption is valid for most objects and typical arrangements of the hardware because displacement vectors 462 and 464 may be approximated as the same direction. This assumption may be invalid for specular surfaces near geometric configurations that may generate a specular reflection from one illumination unit to the imaging system. However, such specular reflections may only occur for specific geometric orientations, and therefore permit determination of the surface normal and estimation of the depth.

Equations 5 and 6 can be combined to eliminate the constant c and give:

$$\frac{{m}_{f} {d}_{f}^{2}}{cos {θ}_{f}} = \frac{{m}_{b} {d}_{b}^{2}}{cos {θ}_{b}} \qquad Eq . 7$$

Let

$$ρ = \frac{cos {θ}_{b}}{cos {θ}_{f}} .$$

Then Eq. 7 can be solved to give the following.

$${d}_{b}^{2} = \frac{{m}_{f}}{{m}_{b}} ρ {d}_{f}^{2} \qquad Eq . 8$$

### Value of ρ

The value of ρ can be reasonably assumed to be 1, which means cos θ_{b}=cos θ_{f} and will be referred to as the equal angle assumption. For example, the assumption is valid for objects that have surface normals approximately in the direction of the illumination unit at the front and back positions. For these surfaces cos θ_{b} and cos θ_{f} are both near 1. Since the cosine function is relatively flat (derivative near 0) for cosine values near 1, small variations in the angle give approximately the same cosine value. Therefore, surfaces with such shapes meet the assumption despite their position. In the simplest form, the disclosed methods may be run using a value of 1 for all points.

### Geometry

Referring to FIG. 4, let α_{b} be the angle between the optical axis of an image sensing unit 404a and displacement vector 462. Let α_{f} be the angle between the optical axis of image sensing unit 404b and displacement vector 464. Consider the triangle formed by object point 460 in the scene and the illumination unit at back position 402a and the illumination unit at front position 402b. One side of the triangle is displacement vector 464, which has length d_{f}. Another side of the triangle is displacement vector 462, which has length d_{b}. The third side of the triangle is displacement between illumination unit 404a-b at the front and back positions and has length A. The following equation results from applying the law of cosines to the triangle.

d_{b}²=d_{f}²+Δ²−2 Δd_{f} cos(π−α_{f}) Eq. 9

This can be simplified by applying a trigonometric identity.

d_{b}²=d_{f}²+Δ²+2 Δd_{f} cos(α_{f}) Eq. 10

Equations 8 and 10 can be combined to obtain the following equation.

$$\frac{{m}_{f}}{{m}_{b}} ρ {d}_{f}^{2} = {d}_{f}^{2} + {Δ}^{2} + 2 Δ {d}_{f} cos ( {α}_{f} ) \qquad Eq . 11$$

The ratio of the measurements is given by the following equation.

$$\frac{{m}_{f}}{{m}_{b}} = \frac{1}{ρ} ( 1 + \frac{{Δ}^{2}}{{d}_{f}^{2}} + \frac{2 Δ cos ( {α}_{f} )}{{d}_{f}} ) \qquad Eq . 12$$

The following equation results from applying the law of sines to the triangle.

$$\frac{{d}_{f}}{sin ( {α}_{b} )} = \frac{Δ}{sin ( {α}_{f} - {α}_{b} )} \qquad Eq . 13$$

This can be simplified to the following.

$$tan ( {α}_{b} ) = \frac{{d}_{f} sin ( {α}_{f} )}{Δ + {d}_{f} cos ( {α}_{f} )} \qquad Eq . 14$$

The following equations are derived by considering rays of light that pass through the center of an ideal thin lens.

$$\begin{matrix}tan ( {α}_{b} ) = \frac{{r}_{b}}{f} & Eq . 15 \\ tan ( {α}_{f} ) = \frac{{r}_{f}}{f} & Eq . 16\end{matrix}$$

Equations 14 and 15 can be combined to obtain the following equation.

$$\frac{{r}_{b}}{f} = \frac{{d}_{f} sin ( {α}_{f} )}{Δ + {d}_{f} cos ( {α}_{f} )} \qquad Eq . 17$$

Solve Equation 17 for d_{f}.

$${d}_{f} = \frac{{r}_{b} Δ}{f sin ( {α}_{f} ) - {r}_{b} cos ( {α}_{f} )} \qquad Eq . 18$$

Equations 12 and 18 give the following.

$$\frac{{m}_{f}}{{m}_{b}} = \frac{1}{ρ} ( 1 + \frac{{f}^{2} {sin}^{2} ( {α}_{f} )}{{r}_{b}^{2}} - {cos}^{2} ( {α}_{f} ) ) \qquad Eq . 19$$

Equation 19 gives the ratio of the measurements if the reference point and non-reference point correspond to the same point in the scene, e.g., object point 460. This ratio is caused by the different distance from the illumination source to the point in the scene, e.g., object point 460, and the resultant different intensity of light in the scene. Let the ratio caused by the illumination be given by s(r_{b}, r_{f}), which is defined as:

$$s ( {r}_{b} , {r}_{f} ) = \frac{1}{ρ} ( 1 + \frac{{f}^{2} {sin}^{2} ( {α}_{f} )}{{r}_{b}^{2}} - {cos}^{2} ( {α}_{f} ) ) \qquad Eq . 20$$

Note that the value of s is determined by specifying the known value of f, an estimate of ρ, and the position of the front and back points. The position of the hack point directly gives r_{b} by finding the distance from the pixel to the center of the sensor. The position of the front point directly gives r_{f} by finding the distance from the pixel to the center of the sensor. Then α_{f} can be found from r_{f} using Equation 16.

Some examples of controllers, such as processing unit 110 may include non-transient, tangible, machine readable media that include executable code that when run by one or more processors may cause the one or more processors to perform the processes of imaging apparatus 400. Some common forms of machine readable media that may include the processes of method 500 and/or method 600 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A system, comprising:
a movable illumination unit;
a movable image sensing unit having a fixed position relative to the movable illumination unit;
a memory;
one or more processors coupled to the memory and configured to read instructions from the memory to cause the system to perform operations comprising:
receiving a reference image from the movable image sensing unit, the reference image being captured when the movable image sensing unit and the movable illumination unit are located at a first position;
receiving a non-reference image from the movable image sensing unit, the non-reference image being captured when the movable image sensing unit and the movable illumination unit are located at a second position, the second position being separated from the first position by at least a translation along an optical axis of the movable image sensing unit; and
estimating a depth of a point of interest that appears in the reference and non-reference images based on the translation along the optical axis of the movable image sensing unit.

2. The system of claim 1, wherein the illumination unit is a primary source of illumination to the point of interest.

3. The system of claim 1, wherein estimating the depth of the point of interest comprises:
selecting the point of interest in the reference image;
determining, from candidate points, a matching point in the non-reference image that corresponds to the point of interest in the reference image; and
estimating the depth of the point of interest based on a location of the point of interest within the reference image and a location of the matching point within the non-reference image.

4. The system of claim 3, wherein determining the matching point in the non-reference image comprises correcting for an intensity difference between the reference and non-reference images based on a distance of the translation along the optical axis of the movable image sensing unit.

5. The system of claim 3, wherein determining the matching point in the non-reference image further comprises correcting for an intensity difference between the reference and non-reference images based on the location of the point of interest within the reference image and the location of the matching point within the non-reference image.

6. The system of claim 3, wherein determining the matching point in the non-reference image further comprises selecting a reference patch in the reference image corresponding to the point of interest in the reference image and selecting a plurality of non-reference patches in the non-reference image corresponding to each of the candidate points, the reference patch and the non-reference patches being used to calculate a cost function for each candidate point.

7. The system of claim 3, wherein determining the matching point in the non-reference image further comprises determining a scaling factor based on the location of the point of interest within the reference image and the location of the matching point within the non-reference image, the scaling factor being used to calculate a cost function for each candidate point.

8. The system of claim 7, wherein the cost function is determined using a cost function c(s(r_{b},r_{f})\vec{p_{b}},\vec{p_{f}}), where s(r_{b},r_{f}) is the scaling factor, and \vec{p_{b}} and \vec{p_{f}} are measurements associated with the reference point and a non-reference point, respectively, the non-reference point corresponding to one of the candidate points.

9. The system of claim 8, wherein the scaling factor is determined using a function:
$$\frac{1}{ρ} ( 1 + \frac{{f}^{2} {sin}^{2} ( {α}_{f} )}{{r}_{b}^{2}} - {cos}^{2} ( {α}_{f} ) )$$
where:
r_{b} and r_{f} are a back radius and a front radius, respectively;
ρ is a ratio given by
$$\frac{cos {θ}_{b}}{cos {θ}_{f}} ;$$
f is a focal length of the image sensing unit; and
α_{f} is given by
$$tan ( {α}_{f} ) = \frac{{r}_{f}}{f} .$$

10. The system of claim 3, wherein the first and second positions are separated by at least one displacement other than the translation along the optical axis of the movable image sensing unit, the at least one displacement including one or more of a rotation and a translation along an axis other than the optical axis of the movable image sensing unit.

11. The system of claim 10, wherein the candidate points include points on an epipolar ray that extends outward from an epipole of the non-reference image and through a point at a same relative position within the non-reference image as the point of interest within the reference image.

12. The system of claim 3, wherein the operations further comprise transforming the reference and non-reference images into a polar coordinate system.

13. A method, comprising:
receiving a reference image from an image sensing unit, the reference image being captured when the image sensing unit is located at a first position and an illumination unit is located at a fixed position relative to the image sensing unit;
receiving a non-reference image from the image sensing unit, the non-reference image being captured when the image sensing unit is located at a second position, the second position being separated from the first position by at least a translation along an optical axis of the image sensing unit; and
estimating a depth of a target feature appearing in the reference and non-reference images based on the translation along the optical axis of the image sensing unit.

14. The method of claim 13, wherein estimating the depth of the target feature comprises:
selecting the target feature in the reference image;
determining a matching feature in the non-reference image that corresponds to the target feature in the reference image; and
estimating the depth of the target feature based on a location of the target feature within the reference image and a location of the matching feature within the non-reference image.

15. The method of claim 14, wherein determining the matching feature in the non-reference image comprises correcting for an intensity difference between the reference and non-reference images based on a distance of the translation along the optical axis of the movable image sensing unit.

16. The method of claim 14, wherein determining the matching feature in the non-reference image further comprises correcting for an intensity difference between the reference and non-reference images based on the location of the target feature within the reference image and the location of the matching feature within the non-reference image.

17. The method of claim 14, wherein determining the matching feature in the non-reference image further comprises selecting a reference patch in the reference image corresponding to the target feature and a plurality of non-reference patches in the non-reference image corresponding to a plurality of candidate points, the reference patch and the non-reference patches being used to calculate a cost function for each of the plurality of candidate points.

18. A system for measuring the depth of an object, the system comprising:
a light source;
a camera rigidly coupled to the light source;
a positioner coupled to at least one of the camera and the light source, the positioner being configured to move the camera and the light source along an optical axis of the camera; and
an image processor coupled to receive a front image and a back image from the camera, the front image and back image being captured at two different positions along the optical axis of the camera, wherein the image processor is configured to measure the depth of the object based on the front image and the back image.

19. The system of claim 18, wherein the light source is configured as a ring of lights, the camera being disposed within the ring of lights.
